(19) United States
(12) Patent Application Publication
(10) Pub. No.: US 2009/0094611 A1
(43) Pub. Date: Apr. 9, 2009

(54) Method and Apparatus for Load Distribution in Multiprocessor Servers

(76) Inventors: Anders Danne, Kista (SE); Christer Boberg, Tungelsta (SE); Kristoffer Gronowski, Stockholm (SE)

Correspondence Address: ERICSSON INC., 6300 LEGACY DRIVE, M/S EVR 1-C-11, PLANO, TX, 75024, US

(21) Appl. No.: 12/097,297

(22) PCT Filed: Dec. 15, 2005
(86) PCT No.: PCT/SE05/01931

§ 371 Date: Sep. 16, 2008

(51) Int. Cl. G06F 9/46

(52) U.S. Cl. 718/105

(57) ABSTRACT

A method and arrangement for handling incoming requests for multimedia services in an application server having a plurality of processors. A service request is received from a user, requiring the handling of user-specific data. The identity of the user or other consistent user-related parameter is extracted from the received service request. Then, a scheduling algorithm is applied using the extracted identity or other user-related parameter as input, for selecting a processor associated with the user and that stores user-specific data for the user locally. Thereafter, the service request is transferred to the selected processor in order to be processed by handling the user-specific data.

### TECHNICAL FIELD

The present invention relates generally to a method and apparatus for distributing load between processors in a multiprocessor server. In particular, the invention is concerned with reducing delays and complexity when processing service requests.

### BACKGROUND

Various communication devices are available today that are capable of packet-based multimedia communication using IP (Internet Protocol), including fixed or mobile computers and telephones. Multimedia services typically entail IP (Internet Protocol) based transmission of encoded data representing media in different formats and combinations, including audio, video, images, text, documents, animations, etc.

A network architecture called “IP Multimedia Subsystem” (IMS) has been developed by the 3^{rd} Generation Partnership Project (3GPP) as an open standard for handling multimedia services and communication sessions in the packet domain. IMS is a platform for enabling services based on IP transport, more or less independent of the access technology used, and is basically not restricted to any specific services. Thus, an IMS network is used for controlling multimedia sessions, but not for the actual transfer of payload data which is routed over access networks and any intermediate transport networks, including the Internet.

FIG. 1 is an exemplary schematic illustration of a basic scenario when multimedia services are provided by means of an IMS service network. A mobile terminal A is connected to a radio access network 100 and communicates media with a fixed computer B connected to another access network 102, in a communication session S involving one or more multimedia services. There may also be an intermediate backbone network as well, not shown, linking the access networks 100 and 102.

An IMS network 104 is connected to the radio access network 100 and handles the session with respect to terminal A, where networks 100, 104 are typically owned by the same operator. In this example, a corresponding IMS network 106 handles the session on behalf of terminal B, and the two IMS networks 104 and 106 may be controlled by different operators. Alternatively, two communicating terminals may of course be connected to the same access network and/or may belong to the same IMS network. Terminal A may also communicate with a server instead, e.g. for downloading some media or information from a content provider. Moreover, if a terminal is roaming in a visited access network, multimedia services are handled by the terminal's “home” IMS network, i.e. where it is registered as a subscriber.

The session S shown in FIG. 1 is managed by specific nodes in each IMS network, in network 104 generally indicated as “session managing nodes” 108. These nodes typically include S-CSCF (Serving Call Session Control Function), I-CSCF (Interrogating Call Session Control Function) and P-CSCF (Proxy Call Session Control Function). Each IMS network 104,106 also includes, or is connected to, application servers 110 for enabling various multimedia services. Further, a main database element HSS (Home Subscriber Server) 112 stores subscriber and authentication data as well as service information, among other things. IMS network 106 is basically similar to network 104. Of course, the IMS networks 104,106 contain numerous other nodes and functions, not shown here for the sake of simplicity, which are of no particular relevance for the present invention.

A specification called “SIP” (Session Initiation Protocol, according to the standard IETF RFC 3261) is used for handling sessions in IMS networks. SIP is an application-layer protocol for signalling, that can be used for establishing and generally handling multimedia sessions. The SIP standard can thus be used by IMS networks and terminals to establish and control IP multimedia communications.

The application servers 110 shown in FIG. 1 are thus used for providing specific multimedia services to subscribers, and may be owned and managed by the operator of the IMS network 104 or by external “third party” service providers. Many services, such as so-called presence services, may involve various group and contact list features and can provide information on other users, e.g., regarding their current location or status. Any such information is held by the respective application servers 110, that is relevant for users subscribing to the services of the application servers. A subscriber may also receive messages and data according to his/her profile as well as current location and status. A user profile may be personal and defined by preferences, interests and hobbies, as well as more temporary factors, such as the user's availability and current moods.

It should be readily understood that such services require the handling of considerable amounts of retrievable user-specific data in the application servers, and in this description, the term “user-specific data” is used to represent any information that is somehow relevant for a user subscribing to a service provided from an application server. WO 2005/088949 describes how user-specific data can be obtained and provided to subscribers. Thus, such user-specific data need to be frequently retrieved and updated in application servers, e.g. in response to service requests. Consequently, it is desirable that service providers can efficiently utilise and control resources of hardware and software means comprised in their application servers.

Moreover, it may be necessary to reconfigure an application server from time to time as the demands from service requests change. Subscribers may be added or removed and services may be introduced, modified or deleted. The popularity of specific services reflected in the number of incoming requests, may also change over time. Scalability is thus also desirable in application servers.

In order to cope with the demands of service requests and great amounts of information, an application server often comprises a plurality of processors with basically similar capabilities and functionality. A so-called load balancer is then used for distributing the load of incoming requests among the processors, by selecting a processor for each request according to some scheduling algorithm. This is necessary in order to efficiently utilise available computing and storing resources, cope with hotspots and avoid bottlenecks. However, it must also be possible to find and retrieve user-specific data from one or more databases, which typically requires the use of pointers or references.

WO 2003/069474 discloses a solution for distributing load of incoming service requests from users between a plurality of servers in a server system, being divided into primary servers adapted for processing tasks and secondary servers adapted for storing tasks. In this context, processing tasks are basically user-independent, whereas storing tasks are basically user-specific. When a service request is received by an access node in the server system, any primary server is randomly assigned by using a first scheduling algorithm, e.g. a Round Robin algorithm. Then, after processing the request, the selected primary server assigns a specific secondary server for a storing task by using a second scheduling algorithm, e.g. a hashing algorithm with a user identity as input. In this way, the processing load will be distributed uniformly among the primary servers, and the user-specific storing load is directed only to servers holding information relevant to the requesting user.

However, application servers with high capacity typically comprises a plurality of uniform processors (sometimes referred to as a “cluster”), each required to retrieve user-specific information from a data storage, whenever dealing with service requests. In order to avoid duplication of stored user data, a large common database is typically used by all processors.

FIG. 2 illustrates a conventional architecture for an SIP application server 200 providing one or more specific multimedia services in an IMS network. Application server 200 includes a load balancer 202, plural mutually similar processors 204, and a common user database 206. Database 206 stores relevant user-specific data for all subscribers or users being registered for the multimedia service(s) provided by the application server 200. Thus, information stored for a user A is in some way related to the user A, regarding either the user himself/herself or other users included in groups defined for that user A.

Incoming service requests from users are initially received in load balancer 202, which applies some suitable scheduling algorithm in order to more or less randomly select processors 204 for handling the requests. In the figure, the scheduling algorithm in load balancer 202 happens to direct a first shown request R1 to processor 1 and a second shown request R2 to processor 3. For example, requests R1 and R2 may concern the same subscriber/user. Since each request R1,R2 typically requires some user-related information, processors 1 and 2 must retrieve such relevant information from the common database 206, as illustrated by double arrows. In this way, any one of the processors 204 can deal with requests from all registered subscribers/users by accessing the database 206.

However, the solution with a large common database increases the time for response to requests, due to the required step of retrieving information from the database. Moreover, if re-transmissions are necessary, which may be the case when UDP (User Datagram Protocol) is used for transporting SIP messages, a re-transmitted message will most likely be directed to a processor different from the one first selected. Therefore, it is also necessary to store current transaction and/or dialogue information for the user in the common database, which will naturally generate further load on that database.

### SUMMARY

The object of the present invention is to address the problems outlined above, and to provide efficient distribution of processing load for incoming service requests. This object and others can be obtained by providing a method and apparatus according to the appended independent claims.

According to one aspect, a method is provided of handling incoming requests for multimedia services in an application server having a plurality of processors. A service request is first received from a user in a first one of the processors, said service request requiring the handling of user-specific data. The identity of the user or other consistent user-related parameter is then extracted from the received service request. Next, a scheduling algorithm is applied using the extracted identity or other user-related parameter as input, for selecting a second one of said processors that is associated with the user and stores user-specific data for that user locally. The service request is finally transferred to the selected second processor in order to be processed by handling said user-specific data.

The service request is preferably received in a stateless front-end part of the first processor, and is transferred to a stateful back-end part of the second processor. The scheduling algorithm may be applied in a distributor arranged between the front-end part of the first processor and a stateful back-end part of the first processor. The distributor may be a central distributor arranged between stateless front-end parts and stateful back-end parts of the processors in the application server, or a local distributor arranged between only the front-end and back-end parts of the first processor.

When a signalling protocol is used for handling the request, the stateless front-end part(s) may operate in a network layer of said signalling protocol, and the stateful back-end part(s) may operate in higher layers of the signalling protocol.

The handling of user-specific data may include any retrieving, modifying and/or storing action for such data.

The application server may be connected to an IMS network, and SIP signalling may be used for the received service request. Then, the distributor may be arranged relative the SIP stack between a stateless network layer and stateful higher layers including an application layer. When the application server is connected to an IMS network, HTTP signalling may also be used for the received service request.

According to another aspect, an arrangement is provided in a first processor of an application server having a plurality of processors for handling incoming requests for multimedia services. The arrangement comprises means for receiving a service request from a user, requiring the handling of user-specific data, and means for extracting the identity of user A or other consistent user-related parameter from the received service request. The arrangement further comprises means for applying a scheduling algorithm using the extracted identity or other user-related parameter as input, for selecting a second one of the processors that is associated with said user and stores user-specific data for that user locally, and means for transferring the service request to the selected second processor in order to be processed by handling said user-specific data.

The receiving, extracting and transferring means are preferably implemented in a stateless front-end part of the first processor adapted to receive and transfer the service request to a stateful back-end part of the selected second processor. The applying means may be implemented in a distributor arranged between said front-end part of the first processor and a stateful back-end part of the first processor. The distributor may be a central distributor arranged between stateless front-end parts and stateful back-end parts of said plurality of processors in the application server, or a local distributor arranged between only said front-end and back-end parts of the first processor. When a signalling protocol is used for handling said request, said stateless front-end part(s) may operate in a network layer of said protocol, and said stateful back-end part(s) may operate in higher layers of the protocol.

The handling of user-specific data may include any retrieving, modifying and/or storing action for such data.

The application server may be connected to an IMS network, and SIP signalling may be used for the received service request. Then, the distributor may be arranged relative the SIP stack between a stateless network layer and stateful higher layers including an application layer. When the application server is connected to an IMS network, HTTP signalling may also be used for the received service request.

According to another aspect, an application server is provided having a plurality of processors for handling incoming requests for multimedia services. Each processor comprises a stateless front-end part adapted to receive service requests, a stateful back-end part adapted to process service requests, and a storage unit for storing user-specific data locally. A distributor is further arranged between the front-end and back-end parts, which is adapted to apply a scheduling algorithm for a service request from a user, requiring the handling of user-specific data using an identity or other user-related parameter as input, for selecting another one of said processors associated with said user and that stores user-specific data for that user locally.

The distributor may be a central distributor arranged between stateless front-end parts and stateful back-end parts of the processors in the application server, or a local distributor arranged between only the front-end and back-end parts of each single processor.

Further possible features and benefits of the present invention will be explained in the detailed description below.

### BRIEF DESCRIPTION OF THE DRAWINGS

The present invention will now be described in more detail and with reference to the accompanying drawings, in which:

FIG. 1 is a schematic overview of a communication scenario including an IMS network, in which the present invention can be used.

FIG. 2 is a block diagram of an application server according to the prior art.

FIG. 3 is a block diagram of an application server according to one embodiment.

FIG. 4 is a block diagram of an application server according to another embodiment.

FIG. 5 is a block diagram of an application server according to yet another embodiment.

FIG. 6 is an alternative block diagram of an application server according to the embodiment of FIG. 5.

FIG. 7 is a flow chart of a procedure for handling a service request according to yet another embodiment.

### DESCRIPTION OF PREFERRED EMBODIMENTS

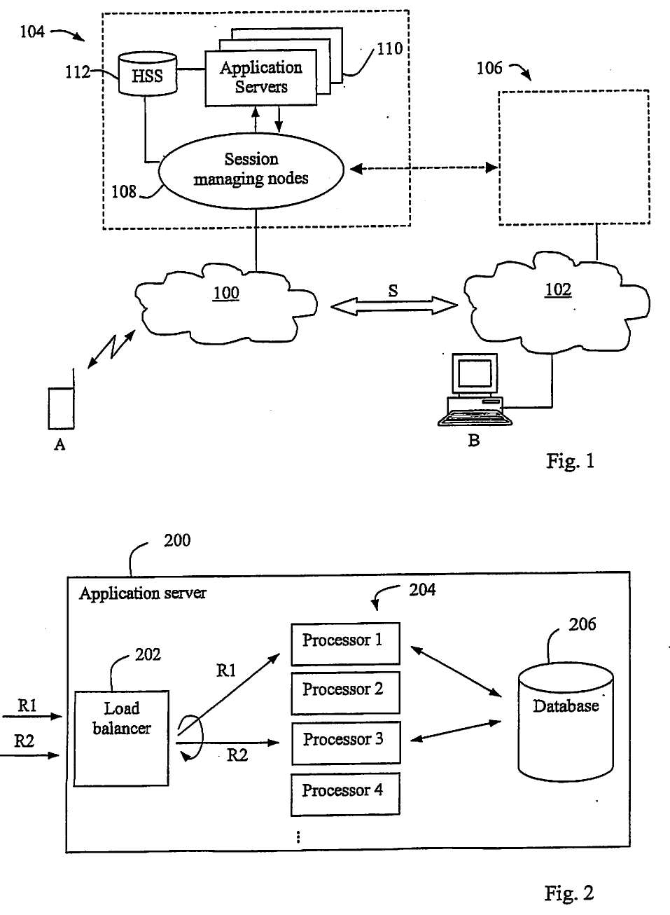

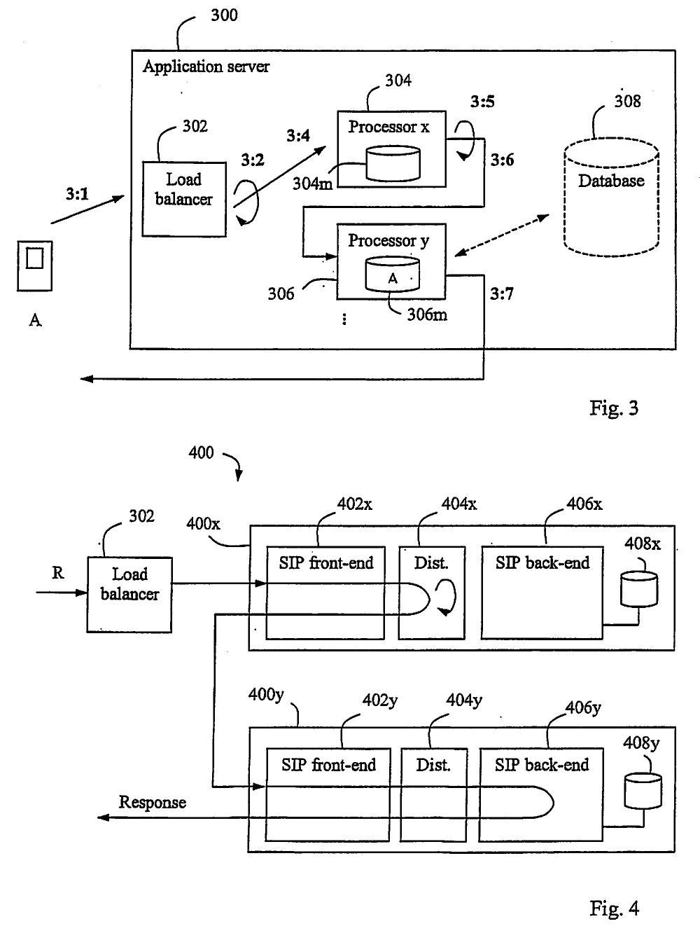

Briefly described, the present invention involves a cluster of processors that stores user-specific data locally, and a mechanism for directing a service request regarding a specific user to a processor storing data for that user. FIG. 3 illustrates an application server 300 and a procedure for handling a service request from a user A, according to one embodiment. The application server 300 may be connected to an IMS network using SIP signalling, e.g. as shown in FIG. 1.

Application server 300 comprises a load balancer 302 acting as an access node for incoming service requests, and a plurality of mutually similar processors of which only two processors 304, 306 are shown having identities x and y, respectively. Each of the processors 304, 306 . . . includes a storage unit or memory for storing user-specific data locally. Thus, a storage unit 304m resides in processor x and a storage unit 306m resides in processor y.

Each local storage unit, e.g. a cache type memory, in the processors can be significantly smaller in capacity, as compared to a large common database accommodating all user data, since only a fraction of the total amount of user-specific data is stored in each local storage unit. In this example, storage unit 304m stores data for a first subset of users associated with processor x, and storage unit 306m stores data for a second subset of users associated with processor y, including user A as indicated therein. Thereby, the same processor will handle all user-specific data locally for a particular user.

In a first step 3:1, a service request is received from user A in the load balancer 302. In a next step 3:2, the load balancer 302 applies a first scheduling algorithm, e.g. of Round Robin type, for selecting any processor more or less randomly to receive and deal with the service request. In this example, load balancer 302 happens to select processor x, 304, and the request is transferred thereto in a step 3:4. It should be noted that load balancer 302 may well operate in the same way as the conventional load balancer 202 of FIG. 2.

If the receiving processor x then detects that the received request requires retrieval, updating and/or storing of user-specific data concerning user A, it is first determined whether the selected processor x is actually associated with user A or not. Most likely, if the application server 300 comprises more than just two or three processors, this is not the case. Therefore, in a next step 3:5, processor x applies a second scheduling algorithm for selecting the one processor being associated with user A, based on the identity of user A or other consistent parameter that can be extracted from the request. The second scheduling algorithm is adapted to always provide the same result for each particular user. For example, a hashing type algorithm may be used with the identity of user A or other user-related parameter as input.

In this example, processor x selects processor y 306, being associated with user A, and the request is further transferred thereto in a step 3:6. Being the correct processor for user A, it can now process the request by means of user-specific data stored for user A in storage unit 306m, and optionally provide some kind of response or other action, depending on the nature of the request and/or service, in a final step 3:7.

In this way, requests not requiring user-specific data are distributed evenly among the processors, while requests actually requiring user-specific data are forwarded to processors associated with the requesting users. It should be noted that the present solution does not exclude the additional use of a common database 306, as indicated in the figure, e.g. for holding certain user-specific data of a more permanent and/or important kind. For example, some types of data may be duplicated in the local storing means and common database, to make it both easily retrievable and safely stored on a long-term basis. In this context, accessing the local storage 306m is much faster than accessing a common database. As compared to conventional solutions, the present solution thus provides for greater flexibility, shorter delays and reduced demands for storage capacity in a common database, if needed at all.

FIG. 4 illustrates in more detail an SIP-based application server 400 comprising a plurality of processors, of which only a first processor 400x and a second processor 400y are shown, although the present invention is not generally limited to the use of SIP. Below, it will be described how an incoming service request R can be forwarded from processor 400x to processor 400y, in accordance with another embodiment. It is assumed that a load balancer 302, using a first scheduling algorithm, initially happens to direct a service request R from a requesting user to processor 400x. Thus, load balancer 302 has basically the same function as described above for FIG. 3.

In this embodiment, each processor is logically divided into an SIP front-end part 402x,y and an SIP back-end part 406x,y, and has a distributor function 404x,y located between the front-end and back-end parts. The processors 400x and 400y further comprise local storage units 408x and 408y, respectively, of limited size.

The SIP front-end parts 402x,y and SIP back-end parts 406x,y operate according to different layers in the SIP protocol stack, such that the front-end parts 402x,y are “stateless” by operating in a network layer of the protocol, and the back-end parts 406x,y are “stateful” operating in higher layers of the protocol, typically including a transaction layer, a resolver layer, a session layer and a context layer. This terminology implies that operation of the stateless front-end parts 402x,y is not affected by changes of user-specific data, whereas operation of the stateful back-end parts 406x,y may be so. Thus, the SIP back-end part basically handles SIP transactions and dialogues.

On top of the SIP stack is the actual application layer in the server 400 for executing one or more applications, not shown, which can be considered as belonging to the back-end parts 406x,y. Between the application layer and the remaining SIP stack is an Application Layer Interface API, e.g. an SIP Servlet API or some JAVA-based communication interface. The SIP structure is well-known in the art, and is not necessary to describe here further to understand the present invention. A similar division of processors into a stateless front end part and a stateful back-end part is also possible for protocols other than SIP, such as HTTP.

The distributor function 404x,y in each processor is adapted to re-direct requests to the correct processors associated with the requesting users, by using a second scheduling algorithm with a user identity or other consistent user-related parameter as input. Thus, when the shown incoming request R reaches the SIP front-end part 402x in processor 400x, it is detected that the request requires user-specific data and the distributor 404x applies the second scheduling algorithm to find the correct processor for the requesting user, i.e. processor 400y in this example. The request is returned to the front-end part 402x which then forwards the request to the processor 400y being selected according to the second scheduling algorithm.

The request R is thus transferred to the processor 400y and enters the SIP front-end part 402y operating in the network layer, which then finally transmits the request to the SIP back-end part 406y for further processing according to higher protocol layers, by means of user-specific data in storage unit 408y. On the other hand, if it was detected in the first processor 400x that the request R does not require user-specific data, it would stay in processor 400x and be transferred directly to the back-end part 406x for processing, without applying the second scheduling algorithm.

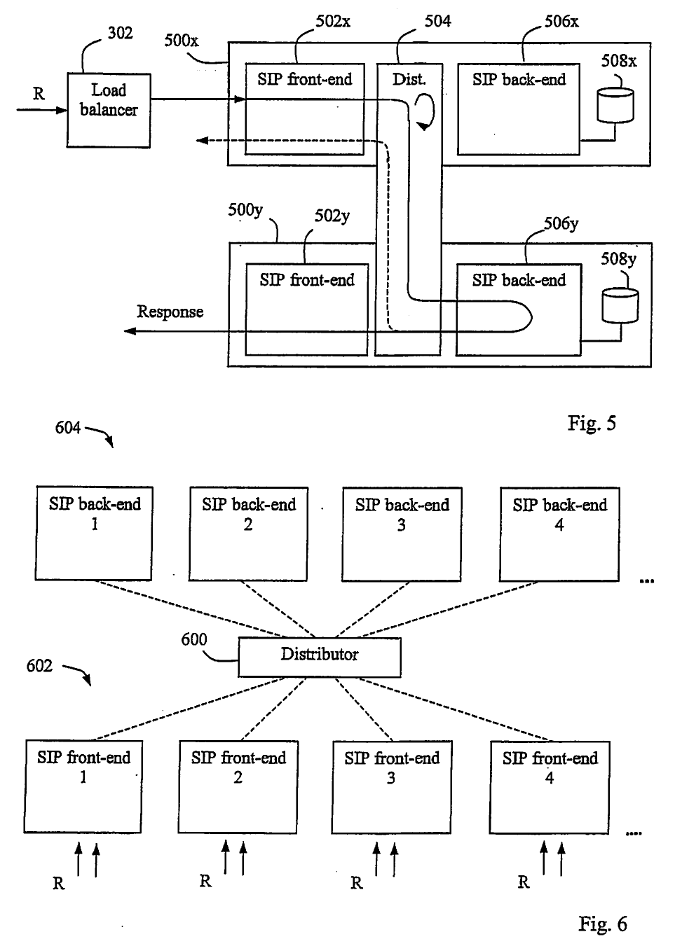

FIG. 5 illustrates an alternative configuration of an SIP-based application server 500, in accordance with yet another embodiment. As in the previous embodiment, server 500 comprises plural processors of which only a first processor 500x and a second processor 500y are shown, and a load balancer 302 which, using a first scheduling algorithm, happens to direct a service request R from a requesting user to processor 500x. The processors comprise stateless SIP front-end parts 502x,y and stateful back-end parts 506x,y, operating in different layers in the SIP protocol stack, as well as local storage units 508x,y, just as in the previous embodiment of FIG. 4. In this embodiment however, a central distributor 504 is located between a plurality of front-end parts and back-end parts in the server, including parts 502x,y and 504x,y.

The central distributor 504 is adapted to re-direct requests from any processors to the correct processors associated with the requesting users. Thus, when the incoming request R reaches the SIP front-end part 502x in processor 500x, it is detected that the request requires user-specific data. The request is therefore forwarded to distributor 504 which applies the second scheduling algorithm to find the correct processor for the requesting user, i.e. processor 500y in this example. In this embodiment, the request is now transferred directly to the SIP back-end part 506y of processor 500y, for further processing by means of user-specific data in storage unit 508y.

After processing the request accordingly, a response or other message may be sent, e.g., to the requesting user by means of the SIP front-end part 502y in the selected processor 500y. Although the present embodiment has been described using SIP signalling, it can also be applied when other signalling protocols are used, such as HTTP (Hypertext Transfer Protocol). If HTTP is used, it would be necessary to send the response from the front-end part 502x of the initially receiving processor 500x, as indicated by a dashed arrow in the figure. Thus, it is required in HTTP to maintain a communication address that was initially given by the load balancer 302 to the requesting user in response to receiving the request.

FIG. 6 is a slightly different illustration of the embodiment described above for FIG. 5, where a central distributor 600 provides a request-distributing link between all stateless SIP front-end parts 602 with all stateful SIP back-end parts 604 of a plurality of processors in an application server. Thus, a request from an SIP front-end part 602 of any processor, requiring user-specific data stored in a specific processor associated with the requesting user, can be re-directed to the correct processor by means of the central distributor function 600, in a manner described above for FIG. 5.

In the embodiments described above for FIGS. 4-6, the distributors 404x,y and the central distributor 504, 600 may further include a set of predetermined rules (not shown) dictating the scheduling algorithm used therein. For example, these rules may determine what parameter in a received service request should be used as input to the algorithm, which may depend on the type message and/or protocol, etc.

The distributors 404x,y and the central distributor 504, 600 in the above embodiments may further receive configuration information from a central administrator or the like (not shown), e.g. if the processor configuration is changed in the application server or if some user-specific data should be moved or deleted from the local storage units. A hashing algorithm used for selecting correct processors may also be changed due to a changed number of processors. Thereby, the distributors 404x,y and the central distributor 504, 600 will remain up to date and provide correct results for incoming service requests.

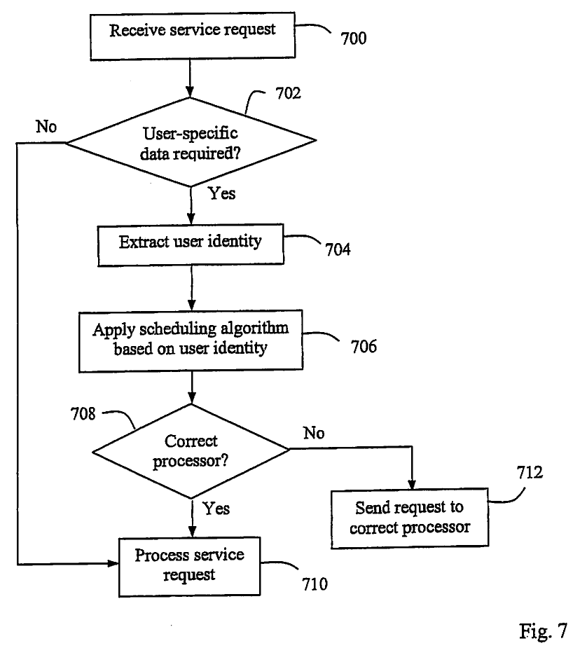

Finally, a procedure of generally processing a service request from a requesting user in a multi-processor application server connected to a multimedia service network, will now be described with reference to the flow chart in FIG. 7. As in the previously described embodiments, each processor in the application server include a local storage unit where different processors store user-specific data for different users. Moreover, the multimedia service network may be an IMS network using SIP signalling, although the present invention is generally not limited thereto.

In a first step 700, the request is received in a more or less randomly selected processor in the application server (e.g. by means of a Round Robin scheduling algorithm), i.e. regardless of the identity of the requesting user. In a next step 702, it is determined whether user-specific data is required for processing the request, i.e. involving any retrieving, modifying and/or storing action for such data. If so, the identity of the requesting user or other consistent user-related parameter is extracted from the request in a step 704, and a scheduling algorithm for finding the correct processor, e.g. a hashing algorithm, is applied based on the extracted user identity or other user-related parameter, in a following step 706.

Thereafter in a step 708, it is determined whether the initially receiving processor is actually the one associated with the requesting user, that is, if the applied scheduling algorithm results in that processor or another one. If the receiving processor is the correct one, (which is unlikely, though) the request can be processed further in a step 710, without transferring the request to another processor. If not, the request is transferred in a step 712 to the processor selected in step 706 by the applied scheduling algorithm. It should be noted that if it was determined in step 702 that no user-specific data is actually required for processing the request, it can be processed by the initially receiving processor, as indicated by the arrow from step 702 directly to step 710.

The present invention, e.g. according to the above-described embodiments of FIGS. 3-7, can provide several benefits when applied in a application server for multimedia services including a cluster of plural processors. By using local storage units in the processors instead of relying on a common database, the delay time for responses or other actions is reduced. The demands for storage capacity in the common database, if used at all, is also reduced.

This solution further provides for flexibility with respect to processor configuration and changes thereof, without hazarding security and reliability. Since one and the same processor will handle all user-specific data for a particular user, the storing and processing loads can be distributed evenly among the processors while consistency is maintained. Furthermore, SIP re-transmissions over UDP will not be a problem, since they will always arrive in the same processor being associated with the requesting user. Ultimately, the performance of multimedia services can be improved and the management of application servers can be facilitated.

While the invention has been described with reference to specific exemplary embodiments, the description is in general only intended to illustrate the inventive concept and should not be taken as limiting the scope of the invention. For example, the SIP signalling protocol and IMS concept have been used throughout when describing the above embodiments, although any other standards and service networks for enabling multimedia communication may basically be used. Further, the invention is not limited to any particular services but may be used for executing any type of service upon request. The present invention is defined by the appended claims.

1. A method of handling incoming requests for multimedia services in an application server having a plurality of processors, comprising the following steps:
receiving a service request from a user in a first one of said processors, said service request requiring the handling of user-specific data,
extracting the identity of said user or other consistent user-related parameter from the received service request,
applying a scheduling algorithm using the extracted identity or other user-related parameter as input, for selecting a second one of said processors that is associated with said user and stores user-specific data for that user locally, wherein the scheduling algorithm includes means for always providing the same result for each particular user, and
transferring the service request to the selected second processor in order to be processed by handling said user-specific data.

2. The method according to claim 1, wherein the service request is received in a stateless front-end part of the first processor, and is transferred to a stateful back-end part of the second processor.

3. The method according to claim 2, wherein said scheduling algorithm is applied in a distributor arranged between said front-end part of the first processor and a stateful backend part of the first processor.

4. The method according to claim 3, wherein said distributor is a central distributor arranged between the stateless front-end part and the stateful back-end part of said plurality of processors in the application server.

5. The method according to claim 3, wherein said distributor is a local distributor arranged between only the front-end part and the back-end part of the first processor.

6. The method according to claim 2, wherein a signalling protocol is used for handling said request, and the stateless front-end part operates in a network layer of the signalling protocol, and the stateful back-end part operates in higher layers of the signalling protocol.

7. The method according to claim 1, wherein said handling of user-specific data includes any retrieving, modifying or storing action for the user-specific data.

8. The method according to claim 2, wherein the application server is connected to an IP Multimedia Subsystem (IMS) network, and Session Initiation Protocol (SIP) signalling is used for the received service request, said distributor being arranged relative to a SIP stack between a stateless network layer and stateful higher layers including an application layer.

9. The method according to claim 2, wherein the application server is connected to an IP Multimedia Subsystem (IMS) network, and Hyper Text Transfer Protocol (HTTP) signalling is used for the received service request.

10. An arrangement in a first processor of an application server having a plurality of processors for handling incoming requests for multimedia services, comprising:
means for receiving a service request from a user, said service request requiring the handling of user-specific data,
means for extracting the identity of the user or other consistent user-related parameter from the received service request,
means for applying a scheduling algorithm using the extracted identity or other user-related parameter as input, for selecting a second one of the processors that is associated with the user and stores user-specific data for that user locally, wherein the scheduling algorithm includes means for always providing the same result for each particular user, and
means for transferring the service request to the selected second processor in order to be processed by handling the user-specific data.

11. The arrangement according to claim 10, wherein said receiving, extracting and transferring means are implemented in a stateless front-end part of the first processor having means for receiving and transferring the service request to a stateful back-end part of the selected second processor.

12. The arrangement according to claim 11, wherein said applying means is implemented in a distributor arranged between the front-end part of the first processor and the stateful back-end part of the first processor.

13. The arrangement according to claim 12, wherein said distributor is a central distributor arranged between the stateless front-end part and the stateful back-end part of the plurality of processors in the application server.

14. The arrangement according to claim 12, wherein said distributor is a local distributor arranged between only the front-end and back-end parts of the first processor.

15. The arrangement according to claim 11, wherein a signalling protocol is used for handling the request, and the stateless front-end part operates in a network layer of the protocol, and the stateful back-end part operates in higher layers of the protocol.

16. The arrangement according to claim 10, wherein said handling of user-specific data includes any retrieving, modifying or storing action for the user-specific data.

17. The arrangement according to claim 11, wherein the application server is connected to an IP Multimedia Subsystem (IMS) network, and Session Initiation Protocol (SIP) signalling is used for the received service request, said distributor being arranged relative to a SIP stack between a stateless network layer and stateful higher layers including an application layer.

18. The arrangement according to claim 11, wherein the application server is connected to an IP Multimedia Subsystem (IMS) network, and Hyper Text Transfer Protocol (HTTP) signalling is used for the received service request.

19. An application server having a plurality of processors for handling incoming requests for multimedia services, each processor comprising:
a stateless front-end part having means for receiving service requests,
a stateful back-end part having means for processing service requests, and
a storage unit for storing user-specific data locally,
wherein a distributor is arranged between the front-end and back-end parts, the distributor having means for applying a scheduling algorithm for a service request from a user, requiring the handling of user-specific data using an identity of the user or other user-related parameter as input, for selecting another one of the processors associated with the user and that stores user-specific data for that user locally, wherein the scheduling algorithm includes means for always providing the same result for each particular user.

20. The application server according to claim 19, wherein the distributor is a central distributor arranged between a stateless front-end part and a stateful back-end part of the plurality of processors in the application server, or a local distributor arranged between only the front-end and back-end parts of each single processor.
